(19) United States
(12) Patent Application Publication
(10) Pub. No.: US 2003/0236892 A1
(43) Pub. Date: Dec. 25, 2003

(54) System for adaptation of SIP messages based on recipient's terminal capabilities and preferences

(76) Inventor: Stephane Coulombe, Irving, TX (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/161,223

(22) Filed: May 31, 2002

(51) Int. Cl. G06F 15/16

(52) U.S. Cl. 709/228

(57) ABSTRACT

A system of Session Initiation Protocol (SIP) terminals capable of processing SIP messages and SIP servers that perform selected functions at the request of the SIP terminals, includes a SIP server (12) for pre-registering capabilities and user preferences of a registering terminal (15) after resolution by a Capability Negotiation Manager (16), and for subsequently receiving an incoming SIP message from a sending terminal (19) indicating a message intended for the pre-registered terminal, and adaptation means (20) for adapting the incoming message to meet the capabilities and user preferences of the pre-registered terminal for transmission by the SIP server to the pre-registered terminal.

### TECHNICAL FIELD

The present invention relates to interoperability between terminal devices using session initiation protocol (SIP) messages and, more particularly, to multimedia content adaptation.

### BACKGROUND ART

Interoperability is of paramount importance in messaging. Users expect that messages will reach their destination and will be handled properly by the recipient's terminal. But emerging mobile terminals have made this requirement more challenging, due to the wide diversity of terminal characteristics: display size and resolution, available memory, formats supported, etc. Sometimes the network also imposes limitations (e.g. maximum message size over UDP).

Content adaptation was addressed in publication EP 1 091 601 A2 in which a sending terminal first checked with a special application service center regarding an intended recipient terminal to find out if it could process a multimedia message. The service center contacted the intended recipient terminal to find out its capabilities. If the intended recipient terminal was not able, the message was posted to a special website and the intended recipient terminal was sent an SMS message with a URL to access the message over the Internet using a PC.

An example of a web browser user interface for low resolution displays can be found in co-owned, co-pending U.S. patent application Ser. No. 09/845,818 filed Apr. 30, 2001 where less than the full extent of high resolution web site content can be selected for viewing on a low resolution display, for instance in a browsing cell phone. An example shows the fall extent of the web page content downloaded to memory in the cell phone and the subsequent processing of that content in the cell phone based on a user's selection of a small portion of the full page.

However, it appears that media content adaptation proxies will play an important role in maintaining interoperability and increasing user experience in many domains of applications including messaging. These proxies, commonly referred as transcoding proxies, actually transform media content to make it suitable for the destination terminal. For instance, one such transformation is format conversion, e.g. PNG to GIF.

Although the need for such transcoding proxies is clear, the framework to facilitate adaptation is not. One exception to this is the specific case of browsing. In browsing, methods to adapt Web pages to different end users have been addressed in the past. But those solutions can't be applied directly to all applications. The dynamics of other applications are often very different from browsing. For instance, in browsing, the destination terminal type is known since such information is provided in the request for content (e.g. User-Agent header in HTTP). In SIP (Session Initiation Protocol) messaging, the recipient doesn't “make a request” to receive a message; it arrives without advance warning. A different mechanism is therefore required in the proxy to obtain the recipient's terminal capabilities.

The invention tries to overcome the problem of interoperability between terminals and to improve the end user experience by providing a framework for making SIP messages conform to the recipient's terminal capability and characteristics. First the message must be able to reach the recipient. Message size reduction may be required for the message to reach the destination terminal due to limited terminal memory or network restrictions. The second aspect relates to the usability of the received message. It needs to be ensured that the content has the appropriate formats, characteristics (e.g., image resolution or audio sampling rate), and presentation (looks good on the small display). The invention describes the mechanisms that make possible such adaptation based on the destination terminal characteristics and user preferences.

The problem was not solved for SIP messages. The need for transcoding services is well-known. In B. Carpenter, S. Brim, “Middleboxes: taxonomy and issues,” draft-carpenter-midtax-01.txt, IETF, Internet Draft, April 2001, transcoders are defined as:

“Transcoders are boxes performing some type of on-the-fly conversion of application level data. Examples include the transcoding of existing web pages for display on hand-held wireless devices, and transcoding between various audio formats for interconnecting digital mobile phones with voice-over-IP services. By definition, such transcoding cannot be done by the end-systems, and at least in the case of voice, it must be done in strict real time with extremely rapid failure recovery. Not all media translators are mandatory. They may just be useful in case of multicast, for example, where all the low-bandwidth receivers sit in one “corner” of the network and it would be inefficient for the sender to generate two streams or send both stream all the way across the network if the “thin” one is only needed far awayfrom the sender. Generally, media translators are only useful if the two end systems don't have overlapping codecs or if the overlapping set is not a good network match.”

There is no mention of how this could work in practice in the context of SIP messages. This requires a solution different from the well-known problem of information browsing. In browsing, a terminal making a request for a Web page will provide his terminal capabilities (often in the form of header fields: User-Agent, Accept, Accept-Encoding, etc.). The Web server will resolve the terminal capabilities, compose an appropriate Web page response and send it. Gateways (such as WAP gateways) also know the terminal capabilities from the Web page request and can perform adaptation accordingly.

In SIP, the messages flow from a sender to a recipient. The proxy is in the middle and doesn't know the capabilities of the recipient since the recipient did not initiate the request. This changes the application dynamics and the adaptation framework used in browsing doesn't apply directly for SIP messages. A new adaptation framework is required. There is no earlier solution providing a framework for SIP message adaptation.

### DISCLOSURE OF INVENTION

An object of the present invention is to provide a framework for SIP message adaptation services.

A method, according to a first aspect of the present invention, comprises the steps of receiving at a server from a registering or subscribing terminal a message having information indicative of capabilities or user preferences of the registering or subscribing terminal, and storing the information for later comparison with the characteristics of an incoming message from another entity and adaptation of the incoming message to match the capabilities or user preferences of the registering or subscribing terminal, if needed.

In further accord with the first aspect of the present invention, the method further comprises the steps of receiving the incoming message, comparing the capabilities or user preferences of the registering or subscribing terminal with the characteristics of the incoming message from the other entity, adapting the incoming message to the capabilities or user preferences of the registering or subscribing terminal, and sending an adapted message to the registering or subscribing terminal.

In still further accord with the first aspect of the present invention, the step of comparing is carried out by a message adaptation engine in communication with the server.

Further still in accord with the first aspect of the present invention, the step of adapting is carried out by a message adaptation engine in communication with the server.

According further to the first aspect of the present invention, the steps of receiving the incoming message and sending the adapted message are carried out at the server.

According still further with the first aspect of the present invention, the method further comprises the step of determining the capabilities or user preferences of the registering or subscribing terminal from the message received by the server from the registering or subscribing terminal prior to the step of storing. The step of determining may be carried out by a capability negotiation manager.

Still further in accord with the first aspect of the present invention, the message received at the server from the registering or subscribing terminal is a session initiation protocol (SIP) register or subscribe message.

In accordance still further with the first aspect of the present invention, the incoming message from the other entity is an SIP message. Likewise, the adaptation of the incoming message may be an adaptation of the incoming SIP message for sending an adapted SIP message to the registering or subscribing terminal.

Further still in accord with the first aspect of the present invention, the registering or subscribing terminal is a mobile terminal. Likewise, the other entity may be a mobile terminal, although it could be a server or any other kind of entity.

A device, according to a second aspect of the present invention, comprises means for receiving at a server from a registering or subscribing terminal a register or subscribe message having information indicative of capabilities or user preferences of the registering or subscribing terminal, and means for storing the information for later comparison with characteristics of an incoming message from another entity and adaptation of the incoming message to match the capabilities or user preferences of the registering or subscribing terminal, if needed.

In further accord with the second aspect of the present invention, the device further comprises means for receiving the incoming message, means for comparing the capabilities or user preferences of the registering or subscribing terminal with the characteristics of the incoming message from the other entity, means for adapting the incoming message to the capabilities or user preferences of the registering or subscribing terminal, and means for sending an adapted message to the registering or subscribing terminal. The means for comparing may comprise a message adaptation engine in communication with the server. The means for adapting may comprise a message adaptation engine in communication with the server. The means for receiving the incoming message and the means for sending the adapted message may both be in the server.

In still further accord with the second aspect of the present invention, the device further comprises means for resolving the capabilities or user preferences of the registering or subscribing terminal from the message received by the server from the registering or subscribing terminal. The means for resolving may comprise a capability negotiation manager.

In accordance still further with the second aspect of the present invention, the register or subscribe message from the registering or subscribing terminal is a session initiation protocol (SIP) message.

Further still in accord with the second aspect of the present invention, the incoming message from the other entity is an SIP message.

According still further to the second aspect of the present invention, the adapted message is an adapted SIP message.

In further accord with the second aspect of the present invention, the registering or subscribing terminal is a mobile terminal.

A system having terminals that are capable of processing messages and servers that perform selected functions at the request of terminals, according to a third aspect of the present invention, includes a server for receiving a registration or subscription request message from a registering or subscribing terminal, a capability negotiation manager for receiving a request from the server to resolve capabilities or user preferences of the registering or subscribing terminal, for resolving the capabilities or user preferences, and for providing information concerning the capabilities or user preferences back to the server, wherein the server, in response to a subsequently received incoming message from a sending entity or terminal intended for the registering or subscribing terminal provides both the incoming message and the information concerning the capabilities or user preferences for use in adapting the incoming message, and adaptation means, responsive to the incoming message and the information concerning the capabilities or user preferences from the server, for adapting the incoming message to a format determined by comparing characteristics of the incoming message to the information concerning the capabilities or user preferences of the registering or subscribing terminal for transmission of an adapted incoming message in that format by the server to the registering or subscribing terminal.

In further accord with the third aspect of the present invention, the registration or subscription request message from the registering or subscribing terminal is a session initiation protocol (SIP) message.

In still further accord with the third aspect of the present invention, the incoming message from the sending entity or terminal is an SIP message.

Still further in accord with the third aspect of the present invention, the adapted incoming message is an SIP message.

Further still in accord with the third aspect of the present invention, the registering or subscribing terminal is a mobile terminal.

A method for use by a device, according to a fourth aspect of the present invention, comprises the steps of providing a registration or subscription message to a server, the message having information indicative of capabilities of the device or preferences of a user of the device for purposes of registering or subscribing the capabilities or user preferences at the server for later comparison at the server with characteristics of an incoming message from another entity and adaptation of the incoming message to match the capabilities of the device or user preferences, if needed, and receiving an adapted message from the server meeting the capabilities or user preferences.

In further accord with the fourth aspect of the present invention, the device is a mobile terminal.

In still further accord with the fourth aspect of the present invention, the registration or subscription message is a session initiation protocol (SIP) message.

Further still in accord with the fourth aspect of the present invention, the adapted message is an adapted SIP message.

Advantages of the invention include:

1) Allowing interoperability between terminals: increased revenues for operators, increased user experience.

2) Compatibility with existing SIP protocol and messaging extensions.

a) Works with many SIP registrations or subscription methods present and future (e.g. REGISTER and SUBSCRIBE methods). In the scope of this invention, we refer as “register message” all registration and subscription requests from the terminal.

b) Works with many SIP messages present and future including Instant Messages and notifications (e.g. MESSAGE and NOTIFY method).

3) Can adapt based on many parameters: terminal capabilities or user preferences (formats, screen resolution, memory), user preferences, network characteristics, etc.

4) May reduce latency and save battery life by performing some adaptation of content characteristics on the server rather than on the terminal (e.g. image resolution reduction).

However, possible disadvantages may include:

1) There is a risk that the adaptation is destructive (small company logo may disappear when image resolution or number of colors is reduced)

2) The sender may not allow the content manipulation.

3) Requires more processing on the server.

These and other objects, features and advantages of the present invention will become more apparent in light of the following detailed description of a best mode embodiment thereof, as illustrated in the accompanying drawing.

### BRIEF DESCRIPTION OF THE DRAWINGS

FIG. 1 shows a typical message flow of SIP message adaptation, according to the present invention.

FIG. 2 shows examples of message adaptation performed according to the present invention.

FIG. 3 shows exemplary details of the system of FIG. 1.

### BEST MODE FOR CARRYING OUT THE INVENTION

As explained earlier, the invention presents a framework for SIP message adaptation services. The framework allows for the adaptation of messages between the sender and recipient. The goal of the adaptation services framework is to facilitate message adaptation in such a way that incoming messages may be made suitable for the recipient's terminal, user's preferences and network characteristics (but not limited to those characteristics) even though the characteristics of the incoming messages may require capabilities quite different from that of the intended recipient terminal.

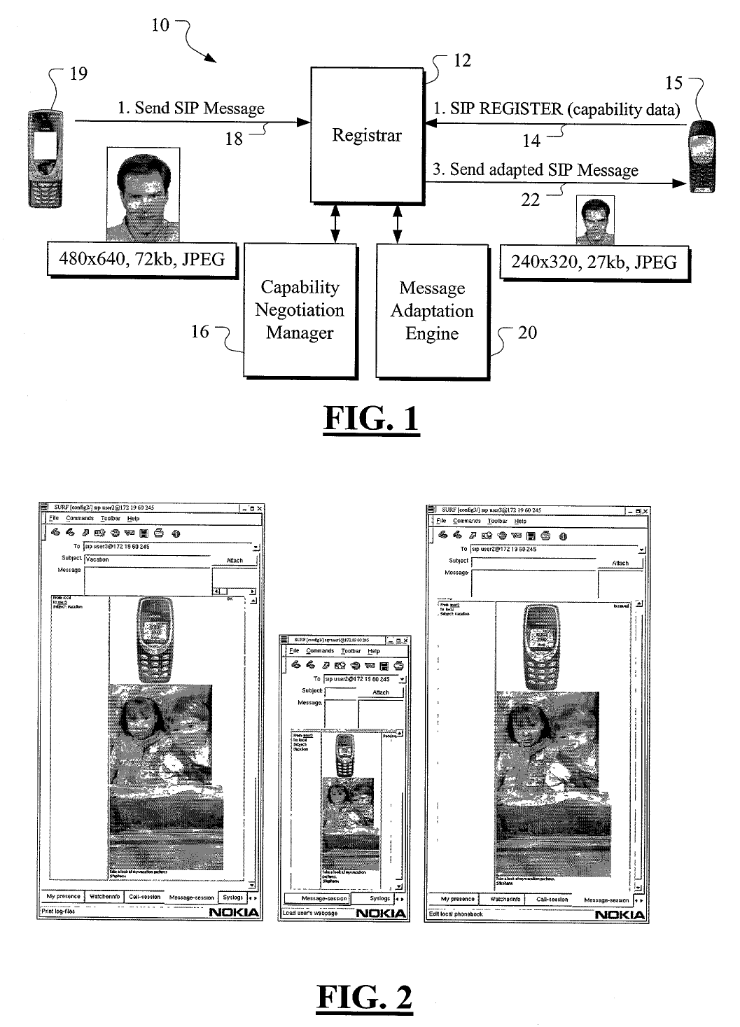

A system 10, according to an embodiment of the invention shown in FIG. 1, comprises three elements in combination: SIP proxy/registrar 12, Capability Negotiation Manager 16 and Message Adaptation Engine 20.

A description of each element and their cooperative relationship follows:

1) SIP proxy/registrar 12: this element performs the operations required by a SIP proxy and registrar specified in RFC 2543 (see M. Handley et al, “SIP: Session Initiation Protocol,” RFC 2543, IETF, March 1999). In addition, it performs the following operations:

a) At the time of registration or subscription (e.g. SIP REGISTER, SUBSCRIBE methods) 14, the registrar “resolves” the terminal capabilities or user preferences of the registering terminal 15 (using the Capability Negotiation Manager Module 16 described below) and stores them along with the registration data (containing the contact addresses). The term “resolve” means to obtain or determine terminal capabilities or user preferences, as explained below, by various possible mechanisms.

b) When a new message 18 arrives at the proxy (e.g. SIP MESSAGE, NOTIFY method) from another entity such as a sending terminal 19, the proxy obtains the terminal capabilities or user preferences of the intended recipient's terminal 15 already stored in the registrar, adapts the message (using the Message Adaptation Engine 20 below), and sends the adapted message 22 to the recipient's terminal 15.

2) Capability Negotiation Manager 16: this element is responsible for resolving terminal capability information. There are many possible mechanisms to obtain the terminal capabilities or user preferences: 1) use of the User-Agent header as a key to a database, called Terminal Capability Database 46, containing terminal characteristics associated with numerous User-Agents; the Terminal Capability Database would return the terminal capabilities or user preferences associated with the specific User-Agent header value 2) use of protocol headers such as Accept header, Accept-Encoding header, etc. 3) URL, where the Capability Negotiation Manager 16 will make an HTTP request to the given URL and will get back some terminal capability information, 4) explicit reporting of the capabilities or user preferences in the registration. All these methods may lead to a different set of capabilities or user preferences and it may be required to complement the capabilities or user preferences obtained by one method with those obtained by others to get a full set of obtainable capabilities or user preferences that is fully reflective of the terminal's capabilities or user preferences. For instance, the capabilities from the URL may not contain some capabilities that are available in the Terminal Capability Database 46. Also, one may want to give more importance to parameters which are more dynamic (e.g. Accept formats that may reflect the user's preferences) rather than something fixed for all terminals of the same model (which may be the case for a Terminal Capability Database). Therefore, it will be understood that “resolve” refers to the operation of 1) gathering all possible capability and preference descriptors from the information received about the terminal (headers, URL, explicit capabilities or user preferences). This operation involves searching databases, making HTTP requests to relevant URLs, etc. 2) Combining the capabilities or user preferences obtained by the different methods in the most appropriate manner to make a complete set of capability information. This may involve combining capability descriptors and giving precedence to some methods over others in the case of duplication of certain capability descriptors (e.g. Accept header and a Terminal Capability Database may contain the information about supported formats, precedence would normally be given to Accept header since it is dynamic and special to the user). The capabilities negotiation manager 16 can (without limitation) resolve capabilities or user preferences from any combination of the following inputs:

a) SIP protocol headers: User-Agent, Accept, Accept-Charset, Accept-Encoding, etc.

b) List of URLs containing the location where the terminal capabilities can be retrieved.

The Capability Negotiation Manager 16 can use the User-Agent header as a key to a terminal capability database (local or external to the Capability Negotiation Manager) containing terminal capability information for each terminal type.

3) Message Adaptation Engine 20: this element is responsible for adapting the message for the recipient terminal. It performs format conversion, presentation adaptation, media characteristics adaptation, message size reduction as needed, encapsulation adaptation (different packaging of the message, different binary encoding, etc.). In general, adaptation is any manipulation or modification of the message content based on the terminal capabilities, user preferences, network conditions, or any characteristics of the user, his terminal or his environment.

The following elements are novel compared to the present SIP-related specifications:

1) Capabilities negotiation for session-oriented and non-session-oriented applications provided during the registration process:

a) In SIP, the registration is used to provide contact information (address to be reached). SIP specification says that message body of REGISTER is for future studies.

b) In SIP, capability negotiation occurs between two clients during session establishment (using SDP (Session Description Protocol)). Without a session, which is the case for instance with SIP instant messaging, there no means of knowing the capabilities or user preferences of the destination terminal.

c) This invention provides a method for capability negotiation regardless if the application is session-based or not.

2) Proxy adapting message based on recipient terminal capabilities or user preferences: It is said in SIP that proxies may transcode content. However, the scope of this claim was mainly for multimedia sessions (audio or video calls) where codecs or the bandwidths between users don't match. In that case, the proxy can use the information in SDP to “fill the gap” between the two terminals. There is no mention that such adaptation could take place for messaging applications and no mention that it should be based on recipient's terminal characteristics. In J. Rosenberg et al., “SIP Extensions for Instant Messaging,” draft-ietf-simple-im-01, IETF, January 2002, which describes SIP extensions for instant messaging, there is no mention of adaptation functionality. It says that if a recipient doesn't support a certain format, it should return an error message (415=Unsupported Media Type) containing an Accept header listing the supported formats. This would tell the sender the valid formats to send.

3) A full system supporting SIP messaging adaptation. This is lacking from SIP messaging.

Thus, the invention provides a framework for SIP message adaptation services including transcoding. The framework permits adaptation of messages between the sender and the recipient. It allows making the messages suitable for the recipient's terminal, user preferences and network characteristics.

Register Operations

The registrar 12, in addition to the operations of a SIP registrar as specified in RFC 2543, is responsible for resolving and storing the terminal capabilities or user preferences for each user. It uses the Capability Negotiation Manager to resolve the capabilities or user preferences upon reception of a register message. Many methods may be used to resolve them, as described above. Regardless of the method used, the obtained terminal capability information (including User-Agent and Accept header fields and other relevant ones) is stored along with the standard registration information for each user. Those capabilities or user preferences are later used by the proxy when receiving an incoming message for that registered user.

Capability Negotiation Manager Operations

At the request of the SIP Proxy/Registrar 12, the Capability Negotiation Manager 16 resolves the terminal capabilities and user preferences using different inputs and methods. Three methods are shown but the system is not limited to them. Some or all those methods can be used in a complementary way (i.e. the information obtained by one method may complement the information obtained by other methods). For the illustrated methods, the registrar 12 receives the SIP register message on the line 14 and provides it to the Capability Negotiation Manager 16 and obtains a set of terminal capabilities and user preferences in return.

In the first method, the terminal provides its capabilities (and the user's preferences) explicitly in the body of the registration message (e.g. REGISTER or SUBSCRIBE methods). The registration message may also contain the User-Agent, Accept, Accept-Encoding, and Accept-Charset header fields. The User-Agent header field describes the terminal type and software version. The Accept header field lists the media formats supported (e.g. image/jpeg or text/plain). This method requires standardization work to define a terminal capability format and vocabulary.

The second method involves using the User-Agent header field as a key to a Terminal Capability Database which contains, for every known User-Agent, the associated terminal's capabilities or user preferences. A Terminal Capability Database 46 in the manager 16 can be consulted for that purpose.

In the third method the terminal sends a list of URLs from which the proxy retrieves terminal capability profile documents via the manager 16.

The capabilities or user preferences are normally resolved during the registration process and stored with the registration. This avoids having to resolve the capabilities or user preferences for each message targeted to a given user. The only exception is when the proxy uses the OPTIONS method (see below).

Proxy Operations

The proxy 12, in addition to the operations of a SIP proxy spelled out in RFC 2453, is responsible for performing transformation of SIP messages. This is illustrated in steps 2 and 3 of FIG. 1. The proxy uses the capabilities or user preferences obtained from the registration or obtains them itself. It then adapts messages with the help of the Message Adaptation Engine (see operations below). More precisely, when the proxy receives a message, it does the following operations:

1. Requests the recipient's terminal capabilities and preferences from the registrar (stored with the registration information). If they are not available, the proxy will initiate a SIP OPTIONS request to the recipient in order to learn its capabilities or user preferences. Those capabilities or user preferences will be resolved with the help of the Capability Negotiation Manager. Depending on the actual capability information received, the Capability Negotiation Manager will use one of the previously described methods to resolve the capability information (explicit capabilities or user preferences, User-Agent with database, URLs). The capabilities or user preferences obtained through the SIP OPTIONS method can be cached for future messages (for that purpose a registration entry with a reasonable expiration time can be created for the user and would contain the obtained terminal capabilities or user preferences).

2. Provides the message along with the recipient's terminal capabilities or user preferences to the Message Adaptation Engine for adaptation. If no capability has been identified in step 1, then it may decide to adapt using default capabilities (e.g. a minimal set of capabilities normally supported by most or all terminals) or may decide that no adaptation is possible except maybe for the network characteristics. The Message Adaptation Engine may add a note to the recipient in the message that it has been adapted. The Message Adaptation Engine returns the adapted message if adaptation was required and successful or the original message otherwise.

3. Sends the adapted message to the recipient (or original message if the message did not need adaptation).

Message Adaptation Engine Operations

The Message Adaptation Engine 20 is responsible for adapting messages. It takes as inputs the original message along with the recipient's terminal capabilities or user preferences. It determines the characteristics of the original message and compares them to the recipient's terminal capabilities or user preferences. It adapts the message, if needed, and returns the adapted message. Adaptation operations performed are usually limited to the message body and include the following:

1) Format conversion: conversion to a media content format supported by the terminal. For instance, PNG images could be converted to GIF if not supported by the recipient's terminal. This category includes conversion of layout formats (e.g. XHTML to WML) and conversion of modality (e.g. speech to text).

2) Media characteristics adaptation: This involves any modification of the media characteristics, including resolution reduction of images for small displays, reducing the quality of JPEG images or the number of colors in GIF images.

3) Presentation or layout adaptation: this involves making the content presentation suitable for the recipient's terminal display characteristics. For instance, the best presentation of a message (e.g. how the images are organized on the display) is different for a landscape orientation display compared to a portrait one.

4) Message size adaptation: reducing the overall message size by reducing the size of the media parts it contains (or removing some of them in the worst case), usually achieved through media characteristics or format conversion. For instance, JPEG images can be reduced in size by reducing their quality factor. This can often be done without significant reduction in the perceived quality, and is required when the original message's size is too large to be supported by the destination terminal (e.g. a 72 kb message is sent to a terminal which supports only 30 kb messages as in FIG. 1).

5) Encapsulation: this refers to the packaging of the data in the message. This may change depending on the network used for the transport. The binary encoding used may also need to be changed (e.g. Accept-Encoding field).

There are three types of SIP servers defined in RFC 2543: Proxy, Redirect and Registrar servers. The foundational elements of the framework needed to carry out this invention have already been implemented in the Nokia Sofia proxy and registrar software. The software is written in C and runs under Linux OS. Many elements of the Nokia MMSC (Multimedia Messaging Service Center) Multimedia Message Adaptation Engine (MMAE) have been reused for that purpose.

So basically the implementation is an extension of existing SIP proxy/registrar servers with a Capability Negotiation Manager and Message Adaptation Engine software. The logic of the SIP proxy/registrar is modified to perform the operations described above supporting adaptation.

FIG. 2 provides an example of SIP message adaptation performed by the Sofia proxy. The original message is shown on the left. Its total size is 43 kb and is composed of four components:

1) A small text message (41 bytes).

2) A GIF image illustrating a phone (195×195 pixels, 16 kb).

3) Two JPEG images (224×220, 15 kb and 250×187, 11 kb).

The original message is sent to two recipients (the middle one and the right one in FIG. 2). The capabilities of the middle terminal include:

1) MaxImageResolution=1160×120

2) Accept=text/plain;image/jpeg

3) MaxMsgSize=25 kb

The capabilities of the terminal on the right include:

1) MaxImageResolution=640×480

2) Accept=text/plain;image/jpeg

3) MaxMsgSize=30 kb

The figure shows the message received for each terminal after adaptation by the Sofia proxy. The middle terminal received a 16 kb message composed of:

1) A small text message (41 bytes).

2) A JPEG image illustrating a phone (97×97, 7 kb). The image was converted to JPEG because the terminal doesn't support GIF.

3) Two JPEG images (112×110, 5.6 kb and 125×93, 3.5 kb).

The terminal on the right received a 29 kb message composed of:

1) A small text message (41 bytes).

2) A JPEG image illustrating a phone (195×195, 8.8 kb). The image was converted to JPEG because the terminal doesn't support GIF either.

3) Two JPEG images (224×220, 9 kb and 250×187, 11 kb).

It is worth noting that message size reduction for the terminal in the middle was achieved as a side effect of the required resolution reductions. For the terminal on the right, no resolution reduction was required, but the message size required reduction. Some size reduction was achieved during the conversion of the first image to JPEG, but an additional quality reduction of the second image was still required in order to meet the size target.

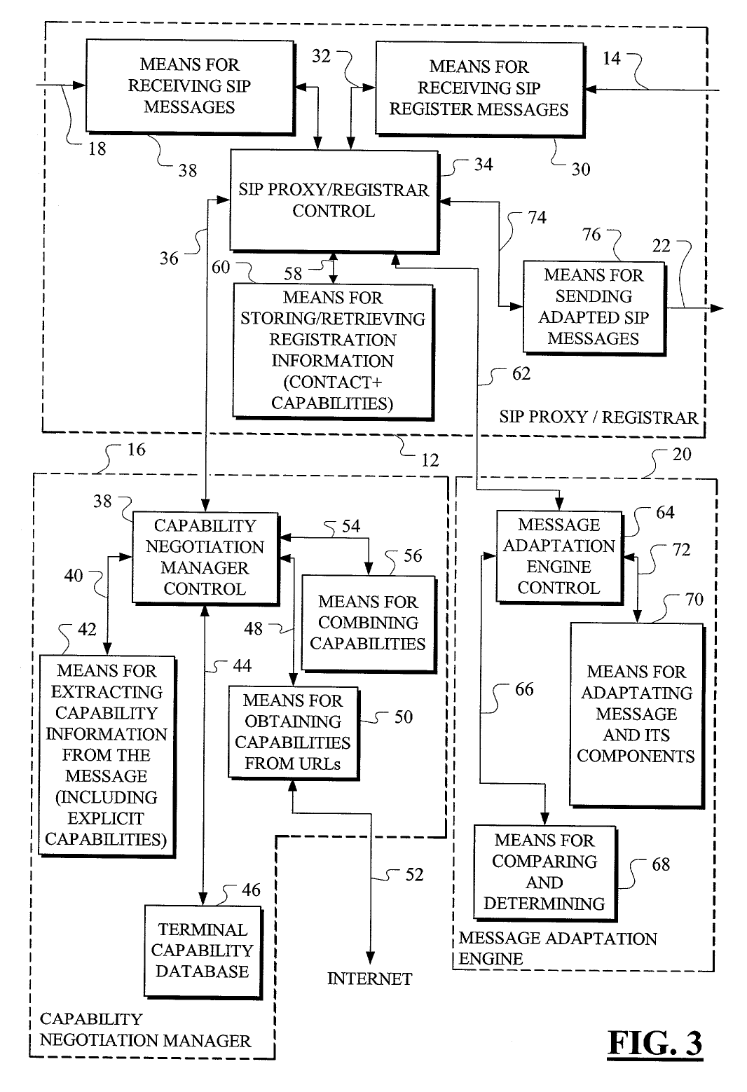

FIG. 3 shows details of one way to carry out the proxy/registrar 12, the Capability Negotiation Manager 16, and the Message Adaptation Engine 20 of FIG. 1. It should be realized that many other configurations and variations are possible, in carrying out the invention as taught herein. The SIP REGISTER message (applying equally to a SIP SUBSCRIBE message and other relevant SIP methods) on the line 14 (with capability data concerning the terminal 15) is received by a receiver 30 and provided on a line 32 to a SIP Proxy/Registrar Control 34. Then the control 34 uses the Capability Negotiation Manager 16 to obtain the capability data associated with the SIP REGISTER message received from the terminal 15. It can do so, for instance, by sending the SIP REGISTER message on a line 36 to a Capability Negotiation Manager Control 38 which provides same on a line 40 to means 42 for extracting capability or user preference information from such a message (including explicit capabilities or user preferences). The extracted capability information is provided by the means 42 back to the control 38 where it may be provided on the line 36 to the server 12 where the capability information may be stored. Or, if the registering terminal has merely identified itself by for instance its model number, the Capability Negotiation Manager control 38 can consult a Terminal Capability Database 46 that contains a list of capabilities of known terminals. The system stores the terminal capabilities or user preferences along with the registration data.

In addition to the possibility that the SIP REGISTER message only gives a limited amount of information about itself and its capabilities (such as the above mentioned model number), it is possible for it to nonetheless give information about how to locate such information, for instance by means of a URL. In that case, the control 38 can forward the URL on a line 48 to a means 50 for obtaining capabilities from URLs by means of a connection 52 to the Internet. Once obtained from the designated URL, the capabilities can be provided by the means 50 to the control 38 for use by means 56 for combining the determined capabilities with others obtained by other methods. For this purpose, the Capability Negotiation Manager Control 38 may also be connected by a signal line 54 to the means 56 for combining capabilities determined by different but complementary methods described above, i.e., combining the various capabilities determined to be resident in a given terminal in order to be in a position to provide a full profile thereof. The Capability Negotiation Manager is thus capable of combining the terminal capability information obtained from different methods in a complementary fashion. The full profile is provided to the SIP Proxy/Registrar Control 34 on a line 36. The SIP Proxy/Registrar Control 34 then forwards the complete registration information (terminal capabilities or user preferences, contact information, etc.) on a line 58 to a means for storing/retrieving registration information 60.

At this point, before any incoming SIP message has arrived on the line 18 from the sending terminal 19, the present invention has provided a novel framework for resolving and pre-registering of the capabilities or user preferences of terminal 15. Upon receipt of the SIP message on the line 18, this pre-registered information about terminal 15 may, according to the present invention, already be available at the means for storing/retrieving registration information 60 for immediate look-up by the proxy/registrar 12, without having to send an inquiry to the intended recipient terminal 15. Therefore, in response to the incoming SIP message on the line 18 indicating a desired message intended for terminal 15, the control 34 sends a signal (containing the destination terminal address) on the line 58 to the means for storing/retrieving registration information 60 in order to find any pre-stored capability information and to retrieve any such pre-stored information from the means for storing/retrieving registration information 60 resident in the SIP Proxy/Registrar 12. If there is no pre-stored capability information found in the database 46 about terminal 15, the control 34 will send an OPTIONS message to the intended destination terminal 15 to get the capabilities or user preferences. In other words, the proxy can use the SIP OPTIONS method (or any appropriate method) to request explicitly the terminal capabilities or user preferences when not already present in the registration data. The message received as a response to the OPTIONS request will be processed similarly to the case when a REGISTER message is received meaning that the SIP proxy/registrar control 34 will request the Terminal Capability Manager 16 to resolve the terminal capabilities or user preferences. The SIP proxy/registrar control 34 may decide to cache those capabilities or user preferences by for instance creating some registration entry about the terminal containing its capabilities or user preferences and storing it in the means for storing/retrieving registration information 60.

The SIP Proxy/Registrar control 34 then provides two inputs on a line 62 to the Message Adaptation Engine 20: (1) the capability information relating to the intended terminal 15 and (2) the incoming SIP message. Both are provided to a message adaptation control 64 in the Message Adaptation Engine 20. The control 64 provides the incoming SIP message (or at least the message characteristics or capability requirements indicated by the incoming SIP message), along with the destination terminal capabilities or user preferences on a line 66, to a means 68 for comparing the two and determining adaptation requirements. The means 68 will make a determination of what sort of adaptation or adaptations are required by comparing the capabilities or user preferences of the intended destination terminal 15 with the incoming message characteristics (e.g., present resolution, format and size of images, size of the message, etc.) for each component thereof. These determined adaptation requirements are provided from the means 68 back to the control 64 and provided on a line 72 to the means 70 for adapting the message and its components to meet the determined adaptation requirements. Adaptation operations are then performed on the message and its components by adaptation means 70 to meet the registering terminal capabilities or user preferences. The Message Adaptation Engine 20 then returns the fully adapted message on the line 62 once the message has been completely adapted (it may correspond to the original if the message was already conforming to the terminal capabilities or user preferences) to the control 34. From there it is provided on a line 74 to a means 76 for sending adapted SIP messages. The sending means 76 then provides the adapted SIP message on the line 22 to the intended recipient terminal.

It will therefore be understood that for the illustrated embodiment the means 20 is for adapting messages within the scope of SIP messaging. It takes a message and a set of capabilities or user preferences that the message must conform to and returns an adapted message conforming to those capabilities or user preferences. This process is performed by comparing message characteristics with terminal capabilities or user preferences and determining adaptation requirements. The adaptation of each message (or component) is then performed by a system taking the determined adaptation requirements and message (or message component) and returning the adapted message or (message component) meeting the capabilities or user preferences of the recipient terminal.

It should be realized that although the embodiment described above utilizes specific SIP methods, the invention applies to a wide variety of SIP registration/subscription message methods related to many services including but not limited to REGISTER and SUBSCRIBE. For that purpose, a different server or SIP server can replace the SIP proxy/registrar used in the description of this invention. Furthermore, the scope of this invention, although very useful in the context of SIP, can be applied to other messaging services and technologies where clients register or subscribe to a server and provide information about their capabilities or user preferences that are stored for future usage by the server to adapt the messages intended to them. Likewise, the invention applies to a wide variety of SIP message methods related to many services including but not limited to MESSAGE and NOTIFY.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

1. Method, comprising the steps of:
receiving at a server (12) from a registering or subscribing terminal (15) a message (14) having information indicative of capabilities or user preferences of the registering or subscribing terminal, and
storing the information for later comparison with the characteristics of an incoming message (18) from another entity (19) and adaptation of the incoming message to match the capabilities or user preferences of the registering or subscribing terminal, if needed.

2. The method of claim 1, further comprising the steps of:
receiving the incoming message,
comparing the capabilities or user preferences of the registering or subscribing terminal with the characteristics of the incoming message from the other entity,
adapting the incoming message to the capabilities or user preferences of the registering or subscribing terminal, and
sending an adapted message to the registering or subscribing terminal.

3. The method of claim 2, wherein the step of comparing is carried out by a message adaptation engine in communication with the server.

4. The method of claim 2, wherein the step of adapting is carried out by a message adaptation engine in communication with the server.

5. The method of claim 4, wherein the step of comparing is carried out by a message adaptation engine in communication with the server.

6. The method of claim 2, wherein the steps of receiving the incoming message and sending the adapted message are carried out at the server.

7. The method of claim 1, further comprising the step of determining the capabilities or user preferences of the registering or subscribing terminal from the message received by the server from the registering or subscribing terminal prior to said step of storing.

8. The method of claim 7, wherein said step of determining is carried out by a capability negotiation manager.

9. The method of claim 1, wherein the message received at the server from the registering or subscribing terminal is a session initiation protocol (SIP) register or subscribe message.

10. The method of claim 1, wherein the incoming message from the other entity is an SIP message and the adaptation of the incoming message is an adaptation of the incoming SIP message for sending an adapted SIP message to the registering or subscribing terminal.

11. The method of claim 1, wherein the registering or subscribing terminal is a mobile terminal.

12. Device, comprising:
means for receiving (30) at a server (12) from a registering or subscribing terminal (15) a register or subscribe message (14) having information indicative of capabilities or user preferences of the registering or subscribing terminal, and
means for storing (60) the information for later comparison with characteristics of an incoming message (18) from another entity (19) and adaptation of the incoming message to match the capabilities or user preferences of the registering or subscribing terminal, if needed.

13. The device of claim 12, further comprising:
means for receiving (38) the incoming message,
means for comparing (68) the capabilities or user preferences of the registering or subscribing terminal with the characteristics of the incoming message from the other entity,
means for adapting (70) the incoming message to the capabilities or user preferences of the registering or subscribing terminal, and
means for sending (76) an adapted message (22) to the registering or subscribing terminal.

14. The device of claim 13, wherein the means for comparing comprises a message adaptation engine (20) in communication with the server.

15. The device of claim 13, wherein the means for adapting comprises a message adaptation engine (20) in communication with the server.

16. The device of claim 15, wherein the means for comparing comprises said message adaptation engine (20) in communication with the server.

17. The device of claim 15, wherein the means for receiving the incoming message and the means for sending the adapted message are both in the server.

18. The device of claim 12, further comprising means (16) for resolving the capabilities or user preferences of the registering or subscribing terminal from the message received by the server from the registering or subscribing terminal.

19. The device of claim 12, wherein the register or subscribe message from the registering or subscribing terminal is a session initiation protocol (SIP) message.

20. The device of claim 12, wherein the incoming message from the other entity is an SIP message.

21. The device of claim 12, wherein the adapted message is an adapted SIP message.

22. The device of claim 12, wherein the registering or subscribing terminal is a mobile terminal.

23. The device of claim 18, wherein said means for resolving comprises a capability negotiation manager.

24. System having terminals that are capable of processing messages and servers that perform selected functions at the request of terminals, comprising:
a server (12) for receiving a registration or subscription request message from a registering or subscribing terminal (15);
a capability negotiation manager (16) for receiving a request (36) from the server to resolve capabilities or user preferences of the registering or subscribing terminal, for resolving the capabilities or user preferences, and for providing information concerning the capabilities or user preferences back to the server, wherein the server, in response to a subsequently received incoming message from a sending entity or terminal (19) intended for the registering or subscribing terminal provides both the incoming message and the information concerning the capabilities or user preferences for use in adapting the incoming message; and adaptation means (20), responsive to the incoming message and the information concerning the capabilities or user preferences from said server, for adapting the incoming message to a format determined by comparing characteristics of the incoming message to the information concerning the capabilities or user preferences of the registering or subscribing terminal for transmission in that format by the server to the registering or subscribing terminal.

25. The system of claim 24, wherein the registration or subscription request message from the registering or subscribing terminal is a session initiation protocol (SIP) message.

26. The system of claim 24, wherein the incoming message from the sending entity or terminal is an SIP message.

27. The system of claim 24, wherein the adapted incoming message is an SIP message.

28. The system of claim 24, wherein the registering or subscribing terminal is a mobile terminal.

29. A method for use by device comprising the steps of:
providing a registration or subscription message to a server, said message having information indicative of capabilities of the device or preferences of a user of the device for purposes of storing said capabilities or user preferences at said server for later comparison with characteristics of an incoming message from another entity and adaptation of said incoming message to match the capabilities or user preferences of the device, if needed; and
receiving said incoming message as an adapted message from the server meeting said capabilities or user preferences, as needed.

30. The method of claim 29, wherein the device is a mobile terminal.

31. The method of claim 29, wherein the registration or subscription message is a session initiation protocol (SIP) message.

32. The method of claim 29, wherein the adapted message is an adapted SIP message.
